(19) United States
(12) Patent Application Publication
(10) Pub. No.: US 2005/0286182 A1
(43) Pub. Date: Dec. 29, 2005

(54) Safety switch

(76) Inventor: Russell John Jackson, Ballarat (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/149,463

(22) Filed: Jun. 9, 2005

(30) Foreign Application Priority Data
Jun. 9, 2004 (AU) 2004903137

(51) Int. Cl. H02H 7/08

(52) U.S. Cl. 361/23

(57) ABSTRACT

A safety switch for controlling the operation of a motor, including a sensor for generating an signal representing an operating condition of the motor; a filter for attenuating a rate of change of said signal and generating a filtered signal; and a controller for generating a control signal for the motor in response to a selected change between said signal representing the operating condition of the motor and the filtered signal.

### BACKGROUND OF THE INVENTION

1. Field of the Invention

The present invention relates to a safety switch. In particular, the present invention relates to a safety switch for a motor.

2. Description of the Related Art

Devices that use the mechanical force generated by an electric motor to rotate a transmission may be subject to shock load and overload conditions during use. For example, an electric drill may become over loaded if material being drilled stops the drill bit from rotating. In the event of any such load condition, excess torque in the motor can cause the device to behave in an unpredictable and potentially dangerous manner. Further examples of difficulties with shock load and overload conditions in motors are set out below.

A shearing hand piece, for example, is driven by a remote electric motor. The mechanical force generated by the motor is transferred to the hand piece by a transmission, also known as a down tube. The down tube is typically a shaft that includes a plurality of rigid shaft segments coupled together in series by knuckle joints. Hinges in these joints permit shaft movement, while the knuckles transmit the rotational motion of each shaft element through the joint towards the shearing hand piece. Despite its widespread use, the shearing hand piece may lock up if the blades of the hand piece become jammed in wool. When such a lock up occurs, excess torque in the remote motor may cause the shaft to twist or swing and thereby wrench the hand piece from the shearer's hand. The shearer and/or the sheep may be subsequently cut by the blades of the hand piece or struck by the heavy knuckle joints. The hand piece may continue to move around uncontrollably until the shearer pulls the remote motor out of gear.

### SUMMARY OF THE CERTAIN INVENTIVE ASPECTS

In accordance with one embodiment, there is provided a safety switch to control the operation of a motor, the safety switch including:
a sensor configured to generate a signal representing an operating condition of the motor;
a filter configured to attenuate a rate of change of said signal and to generate a filtered signal; and
a controller configured to generate a control signal for the motor in response to a predetermined difference between said signal representing the operating condition of the motor and the filtered signal.

The controller may be configured to generate said control signal for the motor if said signal representing the operating condition of the motor is greater than the filtered signal.

The controller may be configured to generate said control signal for the motor if said signal representing the operating condition of the motor is greater than a predetermined threshold.

The safety switch may further comprise an attenuator configured to attenuate said signal representing the operating condition of the motor and to generate an attenuated signal, wherein the controller is configured to generate said control signal for the motor if said attenuated signal is greater than the filtered signal.

The controller may be configured to generate said control signal for the motor if said attenuated signal is greater than said predetermined threshold.

The attenuator may be adjustable so as to change the degree of attenuation used to generate said attenuated signal.

The attenuator may comprise an override to further attenuate said signal representing the operating condition of the motor for a predetermined period of time.

The motor may be an electric motor and the control signal is configured to switch off the motor.

The safety switch may comprise a brake in communication with the controller, said brake being configured to retard the motor on receipt of said control signal from the controller.

The operating condition may be the load on the motor.

The operating condition may be the rotational speed of the motor.

In accordance with another embodiment, there is provided a safety switch to control the operation of a motor, the safety switch comprising:
a sensor configured to generate a signal representing an operating condition of the motor; and
a controller configured to generate a control signal for the motor if said signal representing the operating condition of the motor is greater than a predetermined threshold.

The safety switch may also comprise an attenuator configured to attenuate said signal representing the operating condition of the motor so as to generate an attenuated signal, and wherein said controller is further configured to generate said control signal for the motor if said attenuated signal is greater than the predetermined threshold.

In accordance with another embodiment, there is provided a safety switch to control the operation of a motor, the safety switch comprising:
a sensor configured to generate a signal representing rate of change of an operating condition of the motor; and
a controller configured to generate a control signal for the motor in response to a predetermined condition in said signal representing rate of change of an operating condition of the motor.

The controller may be configured to generate said control signal if the rate of change is above a predetermined threshold.

The motor may be an electric motor and the control signal is configured to switch off the motor.

The safety switch may comprise a brake in communication with the controller, said brake being configured to retard the motor on receipt of said control signal from the controller.

The operating condition may be the load on the motor.

The operating condition may be the rotational speed of the motor.

In accordance with another embodiment, there is provided a safety switch to control the operation of a motor, the safety switch comprising:
a sensor responsive to changes in load of the motor and configured to represent those changes as a signal varying with respect to time;
a filter configured to damp the signal varying with respect to time; and
a controller configured to generate a control signal for the motor if said signal varying with respect to time is greater than the signal damped by the filter.

A motor assembly comprising:
a motor;
a sensor configured to generate a signal representing an operating condition of the motor;
a filter configured to attenuate a rate of change of said signal and to generate a filtered signal; and
a controller configured to generate a control signal for the motor in response to a predetermined difference between said signal representing the operating condition of the motor and the filtered signal.

The controller may be configured to generate said control signal for the motor if said signal representing the operating condition of the motor is greater than the filtered signal.

The controller may be configured to generate said control signal for the motor if said signal representing the operating condition of the motor is greater than a predetermined threshold.

The motor assembly may further comprise an attenuator configured to attenuate said signal representing the operating condition of the motor and to generate an attenuated signal, wherein the controller is configured to generate said control signal for the motor if said attenuated signal is greater than the filtered signal.

The controller may be configured to generate said control signal for the motor if said attenuated signal is greater than said predetermined threshold.

The attenuator may be adjustable so as to change the degree of attenuation used to generate said attenuated signal.

The attenuator may comprise an override to further attenuate said signal representing the operating condition of the motor for a predetermined period of time.

The motor may be an electric motor and the control signal is configured to switch off the motor.

The motor assembly may comprise a brake in communication with the controller, said brake being configured to retard the motor on receipt of said control signal from the controller.

The operating condition may be the load on the motor.

The operating condition may be the rotational speed of the motor.

In accordance with another embodiment, there is provided a safety switch to control the operation of a motor, the safety switch comprising:
means for sensing an operating condition of the motor, and generating a signal representing an operating condition of the motor;
means for attenuating a rate of change of said signal and generating a filtered signal; and
means for generating a control signal for the motor in response to a predetermined difference between said signal representing the operating condition of the motor and the filtered signal.

The means for generating a control signal may be configured to generate said control signal for the motor if said signal representing the operating condition of the motor is greater than the filtered signal.

The means for generating a control signal may be configured to generate said control signal for the motor if said signal representing the operating condition of the motor is greater than a predetermined threshold.

The operating condition may be the load on the motor.

The operating condition may be the rotational speed of the motor.

In accordance with another embodiment, there is provided a method of safety switching to control the operation of a motor, the method comprising:
generating a signal representing an operating condition of the motor;
attenuating a rate of change of said signal and generating a filtered signal; and
generating a control signal for the motor in response to a predetermined difference between said signal representing the operating condition of the motor and the filtered signal.

### BRIEF DESCRIPTION OF THE DRAWINGS

Exemplary embodiments are hereafter described, by way of non-limiting example only, with reference to the accompanying drawings in which:

FIG. 1 is a diagrammatic illustration of a safety switch;

FIG. 2 is a diagrammatic illustration of the safety switch shown in FIG. 1 coupled between a power source and a remote motor;

FIG. 3 is a diagrammatic illustration showing the components of the safety switch shown in FIG. 1;

FIG. 4 is a circuit diagram of the safety switch shown in FIG. 3;

FIG. 5 is a graphical illustration showing an exemplary output signal of the hall effect sensor of the safety switch shown in FIGS. 3 and 4;

FIG. 6 is a graphical illustration of an attenuated output signal of a calibrator of the safety switch shown in FIGS. 3 and 4;

FIG. 7 is a graphical illustration of a rectified output signal of a full wave rectifier of the safety switch shown in FIGS. 3 and 4;

FIG. 8 is a graphical illustration of a smoothed output signal of a peak picker filter of the safety switch shown in FIGS. 3 and 4;

FIG. 9 is a graphical illustration of a damped output signal of a damping filter of the safety switch shown in FIGS. 3 and 4;

FIG. 10 is a graphical illustration of a voltage limited output signal of a voltage limiter of the safety switch shown in FIGS. 3 and 4;

FIG. 11 is a graphical illustration of an attenuated output signal of a signal attenuator of the safety switch shown in FIGS. 3 and 4;

FIG. 12 is a graphical illustration of a further attenuated output signal of a start up attenuator of the safety switch shown in FIGS. 3 and 4;

FIG. 13 is a graphical illustration showing the performance of the safety switch shown in FIG. 1;

FIG. 14 is a circuit diagram of a braking system of the safety switch shown in FIG. 4;

FIG. 15 is a circuit diagram of an alternative embodiment of the safety switch shown in FIG. 1;

FIG. 16 is a graphical illustration showing the performance of the safety switch shown in FIG. 15;

FIG. 17 is a graphical illustration showing the state of the components of the safety switch shown in FIG. 15 at different stages of use;

FIG. 18 is an alternative circuit diagram for the safety switch shown in FIG. 3;

FIG. 19 is another alternative circuit diagram for the safety switch shown in FIG. 3;

FIG. 20 is yet another alternative circuit diagram for the safety switch shown in FIG. 3;

FIG. 21 is a diagrammatic illustration of a safety switch in accordance with an exemplary embodiment;

FIG. 22 is a diagrammatic illustration of the safety switch shown in FIG. 21 coupled between a power source and a remote motor;

FIG. 23 is a diagrammatic illustration showing the components of the safety switch shown in FIG. 21;

FIG. 24 is a circuit diagram of the safety switch shown in FIG. 21;

FIG. 25 is a circuit diagram of the braking system of the safety switch shown in FIG. 24;

FIG. 26 is a graphical illustration showing the state of components of the safety switch shown in FIG. 21 at different stages of use;

FIG. 27 is a graphical illustration showing the state of components of the safety switch shown in FIGS. 21 and 25 at different stages of use; and

FIG. 28 is a graphical illustration showing the performance of a safety switch in accordance with an exemplary embodiment.

### DETAILED DESCRIPTION OF CERTAIN INVENTIVE ASPECTS

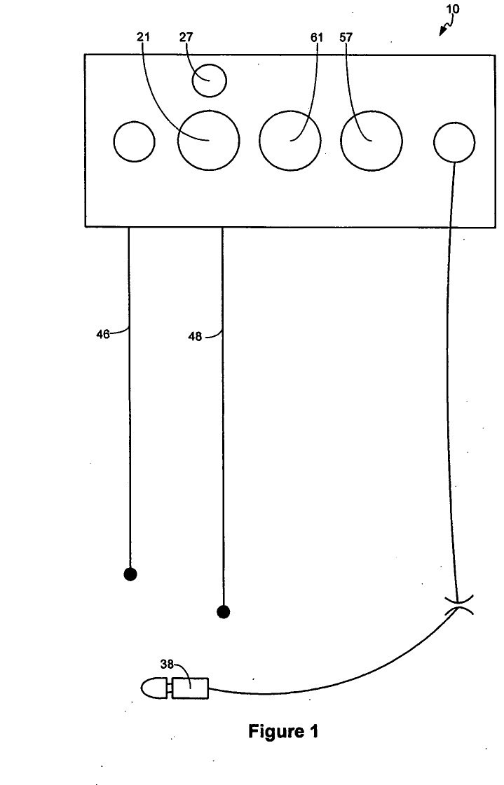

The safety switch 10 shown in FIG. 1 is used to control the operation of a motor (not shown). The safety switch 10 includes a sensor (not shown) that generates a signal representing an operating condition of the motor and a filter (also not shown) for attenuating a rate of change of the signal and generating a filtered signal. The safety switch 10 generates a control signal to retard the motor when it detects that the signal representing the operating condition of the motor is greater than the filtered signal, i.e. when it detects a shock load on the motor. The safety switch 10 also generates a control signal to retard the motor when the safety switch 10 detects that the signal representing the operating condition of the motor is greater than a predetermined threshold, i.e. when it detects an overload condition. The safety switch 10 retards the motor by cutting power to the motor, for example. Alternatively, the safety switch 10 retards the motor using a braking system, a clutch or any other suitable means.

It will be understood by those skilled in the relevant art that the sensor could monitor any one of number of operating conditions on the motor. However, the safety switch is hereafter described by way of non-limiting example with reference to the sensor monitoring:
1. The load on the motor; and
2. The rotational Speed of the Motor.
   1. The Load on the Motor

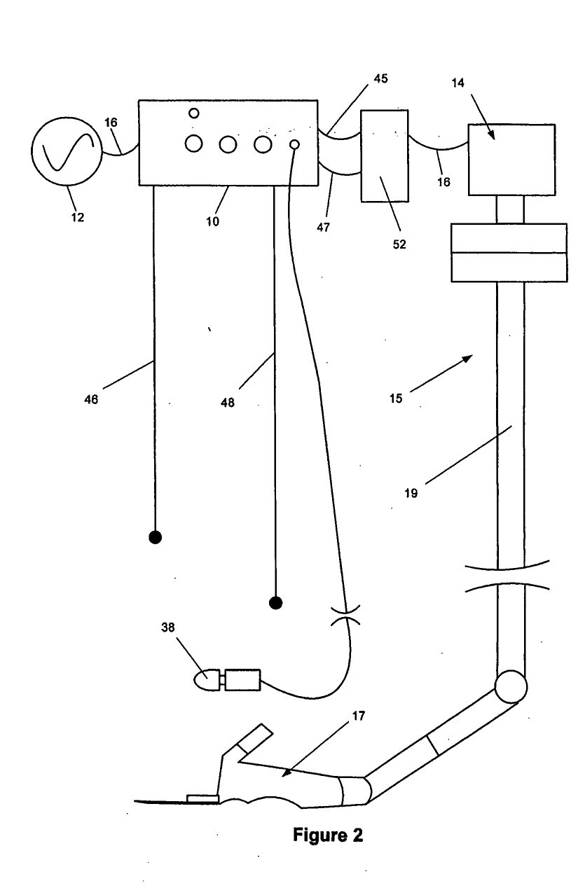

The safety switch 10 is used to control the remote electric motor 14 of the shearing apparatus 15 shown in FIG. 2. However, it would be understood by those skilled in the relevant art that the safety switch 10 can be used to monitor the load of any electric motor. The shearing apparatus 15 includes a power source 12 and a hand piece 17. The mechanical force of the motor 14 drives the handpiece 17 via a down tube 19. The motor 14 is a three phase induction motor 14 that can be controlled by a frequency inverter.

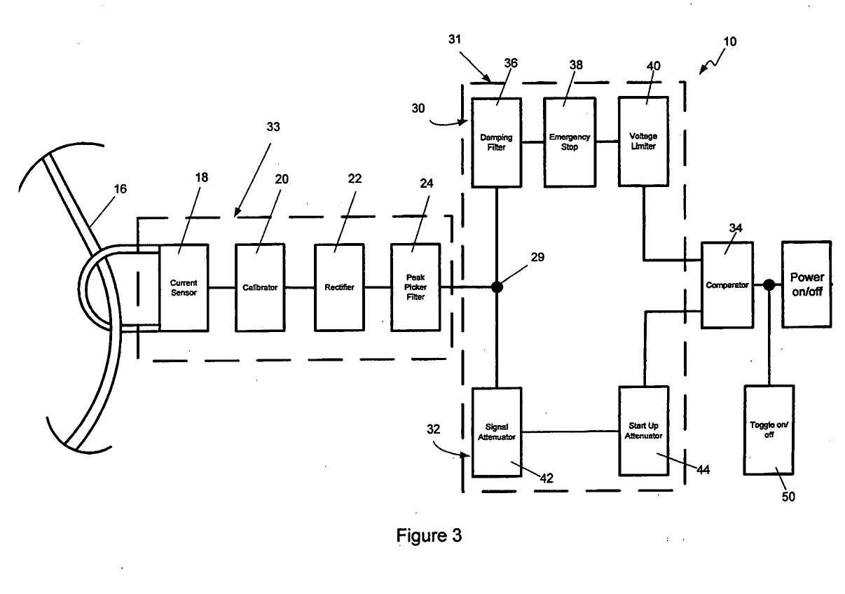

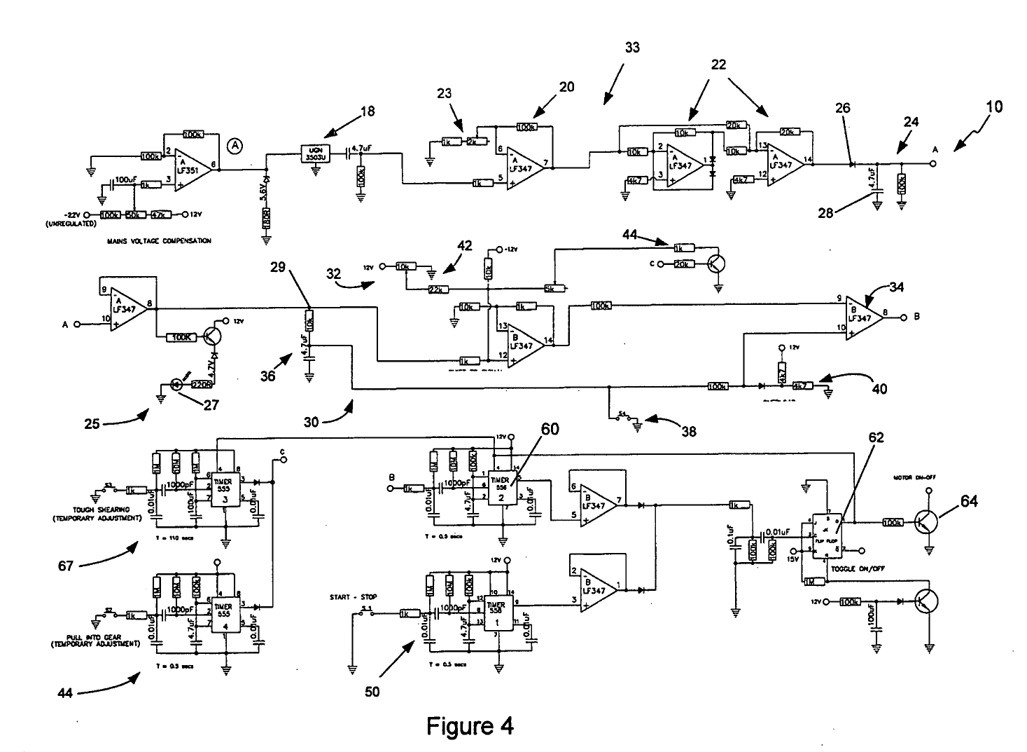

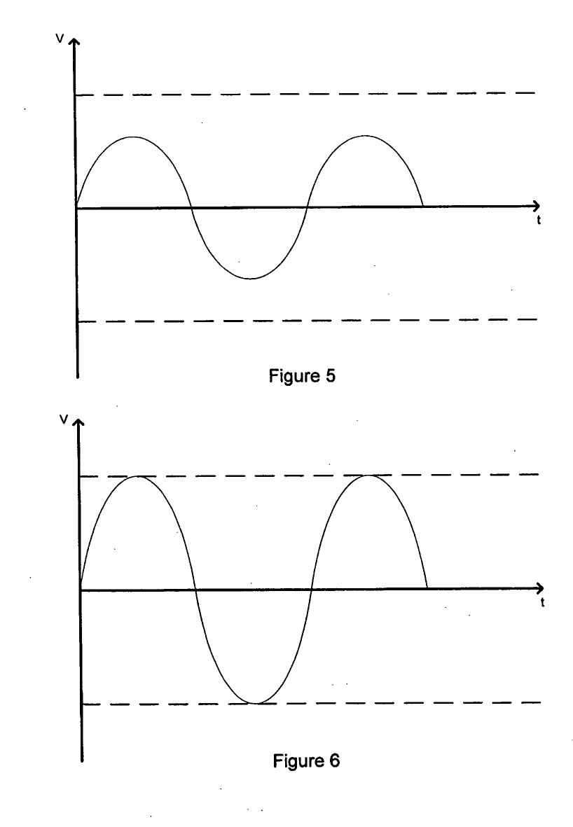

The safety switch 10 includes a tracking system 31 coupled between a sensor 33 and a comparator 34 arranged in the manner shown in FIGS. 3 and 4. The sensor 33 includes a Hall effect current sensor 18 that detects changes in magnetic flux density in the current being supplied to the remote motor 14 on the power supply line 16. The current sensor 18 measures changes in magnetic flux density when inserted into the flux lines of the magnetic field generated by the power supply line 16. The sensor 18 represents these changes as a voltage signal varying with respect to time. An example of a typical output signal of the Hall effect sensor 18 is shown in FIG. 5.

The output signal of the Hall effect sensor 18 is received by a calibrator 20 coupled thereto. It is desirable that the safety switch 10 work with different electric motors 14 and, since different electric motors 14 may operate on different voltages, the amplitude of the signal received from the Hall effect sensor 18 may need to be adjusted to best fit the scale of the safety switch 10. The safety switch 10 includes a dial 21 forming part of a calibrator 20 that controls the resistance of a potentiometer 23. By adjusting the dial 21, a person can control the degree of attenuation of the signal received from the Hall effect sensor 18. The person can thereby adjust the amplitude of the signal to best fit the scale of the safety device 10. An example of an attenuated output signal of the calibrator 20 is shown in FIG. 6.

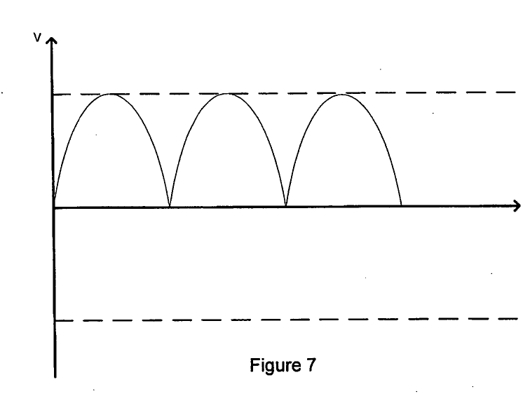

The output signal of the calibrator 20 is received by a full wave rectifier 22 coupled thereto. The output of the full wave rectifier 22 is the absolute value of the attenuated signal that it receives from the calibrator 20. Full wave rectification of the attenuated signal increases the sensitivity of the safety switch 10. An example of a fully rectified attenuated signal is shown in FIG. 7.

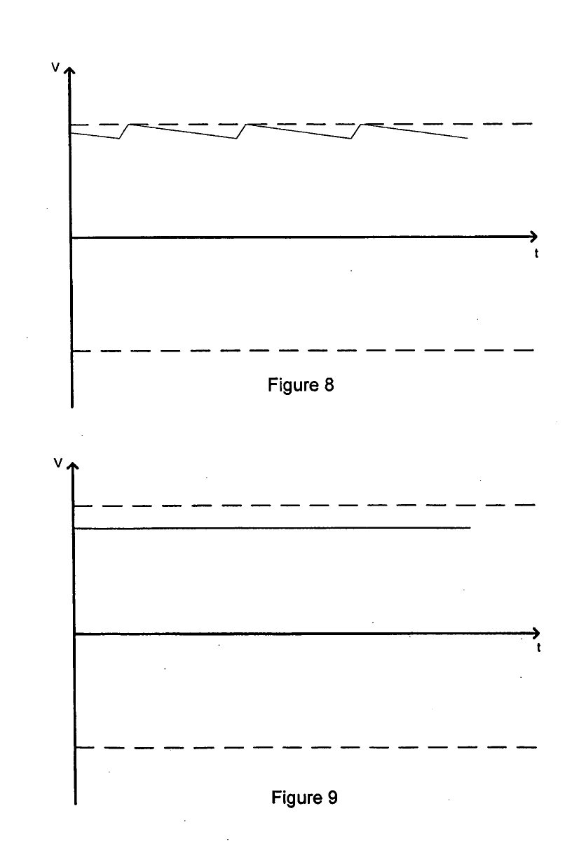

The fully rectified signal is received by a peak picker filter 24 coupled thereto. The peak picker filter 24 includes a diode 26 coupled to a capacitor 28 arranged in the manner shown in FIG. 4. The capacitor 28 charges as the voltage of the fully rectified signal increases with respect to time and discharges as the voltage of the fully rectified signal decreases with respect to time. The capacitor 28 thereby smooths the fully rectified signal. An example of the smoothed output of the peak picker filter 24 is shown in FIG. 8.

The smoothed output signal of the peak picker filter 24 is received by an overload indicator 25. The overload indicator 25 illuminates a light emitting diode (LED) 27 on detection of an overload in the remote motor 14. The LED 27 of the overload indicator 25 can be used as a visual aide for calibrating the switch 10, i.e., testing and adjusting the point at which the motor 14 is deemed to be overloaded.

The smoothed output signal of the peak picker filter 24 of the sensor 33 is received by the tracking system 31. The smoothed output signal is split by the tracking system 31 at junction 29 into first and second circuit branches 30, 32. Each circuit branch 30,32 is coupled between the output of the peak picker filter 24 and respective first and second inputs of a comparator 34. The comparator 34 changes state if it detects that the signal received from the second circuit branch 32 is greater than the signal received from the first circuit branch 30.

The First Circuit Branch

A damping filter 36 of the first circuit branch 30 receives and damps the smoothed output signal of the peak picker filter 24. An example of the damped output signal of the damping filter is shown in FIG. 9. The damping filter slows the rate of change in the signal received from the peak filter 24.

The damped output signal of the damping filter 36 is received by an emergency stop switch 38 coupled thereto. When activated, the emergency stop switch 38 grounds the damped output signal of the damping filter 36. The emergency switch 38 otherwise allows the damped output signal of the damping filter 36 to pass through to a voltage limiter 40.

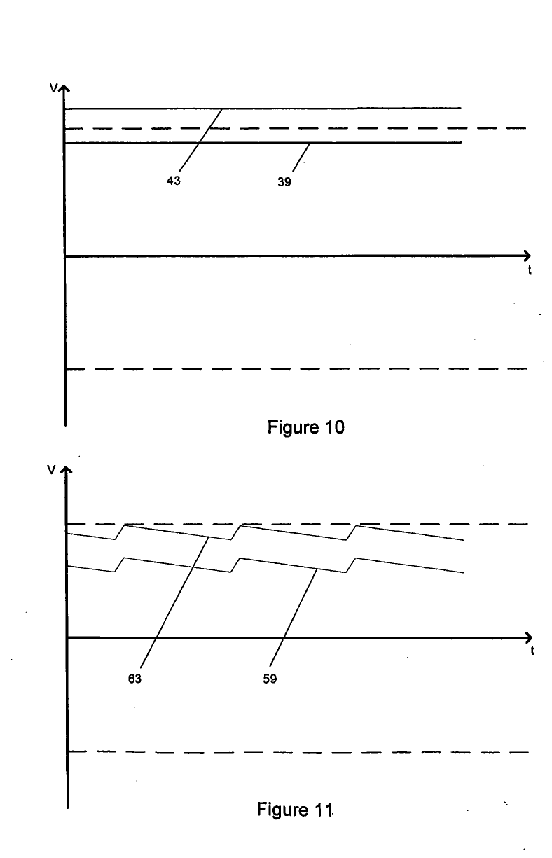

The voltage limiter 40 is coupled between the emergency safety switch 38 and the first input of the comparator 34. When the emergency safety switch 38 has not been activated, the voltage limiter 40 receives the damped output signal from the damping filter 36 and prevents that signal from exceeding a predetermined voltage. An example of the output of the voltage limiter 40 is shown in FIG. 10. The output signal of the damping filter 36 is indicated by reference numeral 39 and the predetermined voltage of the voltage limiter 40 is indicated by reference numeral 43.

Second Circuit Branch

The output of the peak picker filter 24 is also received by the signal attenuator 42 of the second circuit branch 32. The signal attenuator 42 includes a dial 61 that controls the resistance of a variable resistor. A person is able to adjust the attenuation of the smoothed output signal of the peak picker filter 24 by rotating the dial 61 of the safety switch 10. The person is thereby able to adjust the degree to which the amplitude of the signal of the second circuit branch 32 corresponds to that of the first circuit branch 30. An example of an attenuated output signal of the signal attenuator 42 is shown in FIG. 11. The signal received by the first signal branch is indicated by reference numeral 63 and the attenuated signal of the second circuit branch is indicated by reference numeral 59.

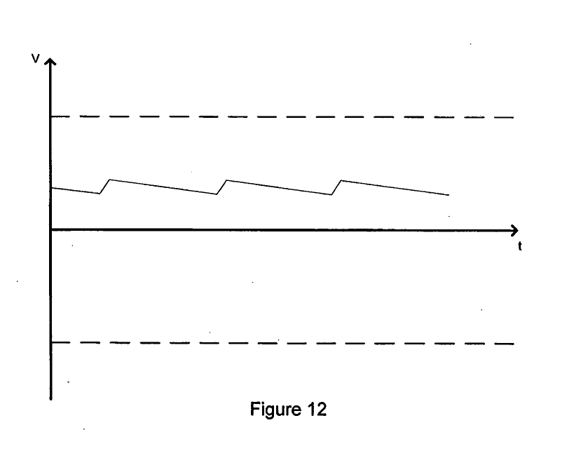

The output of the signal attenuator 42 is received by a start up attenuator 44 coupled thereto. The start up attenuator 44 includes a dial 57 that, when rotated, attenuates the output signal of the signal attenuator 42. The start up attenuator 44 can be used to attenuate the output signal of the signal attenuator 42 in anticipation of a period of excessive load on the motor 14. For example, the load on the motor 14 at start up is typically greater than the load on the motor during normal use and may be sufficient to trigger the safety device 10. The shearer is able use the start up attenuator to prevent the safety switch 10 from prematurely retarding the motor 14. An example of an output signal of the start up attenuator 44 is shown in FIG. 12.

In addition, the start up attenuator 44 is coupled to a tough shearing electronic circuit 67 that allows a shearer to activate the start up attenuator 44, by way of pulling a cord 48 coupled thereto, when they anticipate that the load on the shearing is going to temporarily increase.

The comparator 34 receives an input signal from the voltage limiter 40 of the first circuit branch 30 and an input signal from the start up attenuator 44 of the second circuit branch 32. The comparator 34 compares the voltage levels of these two input signals. The comparator 34 toggles its output from high to low, or vice versa, if it detects that the voltage level of the signal received from the second circuit branch 32 is greater than the voltage level of the signal received from the first circuit branch 30.

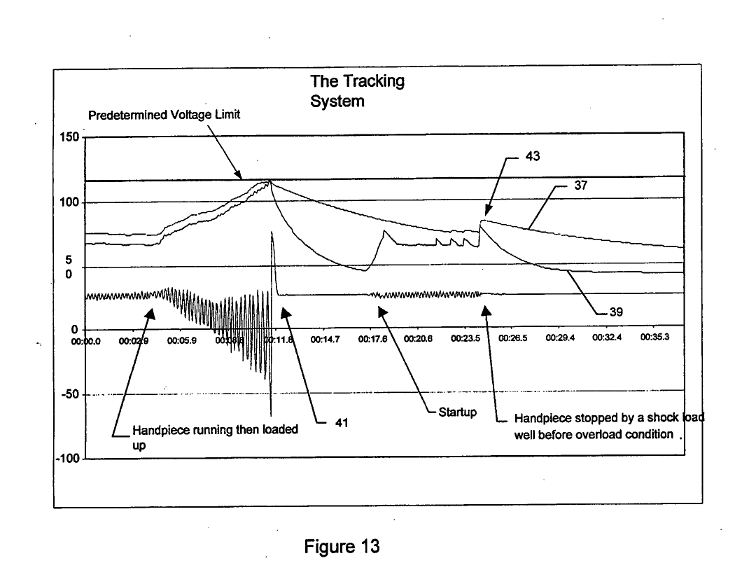

Under normal shearing conditions, the voltage of the damped signal 37 received by the comparator 34 from the first circuit branch 30 will be greater than the voltage of the signal received by the comparator 34 from the second circuit branch 32.

Where a load is slowly applied load to the remote motor 14, the damped signal received by the comparator 34 from the first circuit branch 30 will rise and fall at about the same rate as that of the unfiltered signal received from the second circuit branch 32, as shown in FIG. 13. The damped signal of the first circuit branch 30 is indicated by reference numeral 37 and the unfiltered signal of the second circuit branch 32 is indicated by reference numeral 39. Under normal load conditions, the amplitude of the signal received from the first circuit branch 30 will be greater than that of the signal received from the second circuit branch 32. An overload, indicated by reference numeral 41, occurs when the load on the motor 14 increases to the extent that the amplitude of the damped signal 37 reaches the predetermined limit of the voltage limiter 40 and the amplitude of the unfiltered signal 39 continues to increase until it exceeds the mentioned predetermined limit. At this point, the unfiltered signal 39 becomes greater than the filtered signal 37 and the comparator 34 changes state. The change of state of the comparator 34 causes the motor 14 to be retarded.

A shock load, indicated by reference numeral 43, can occur where the load on the motor 14 is light, such that the amplitude of the signal of the first circuit branch 30 is below that of the predetermined voltage level, and a shock load is applied to the motor 14. In such circumstances, the amplitude of the undamped signal of the second circuit branch 32 may temporarily exceed the amplitude of the damped signal of the first circuit branch 30. On detection of this change, the output of the comparator 34 will change state. The motor is subsequently retarded.

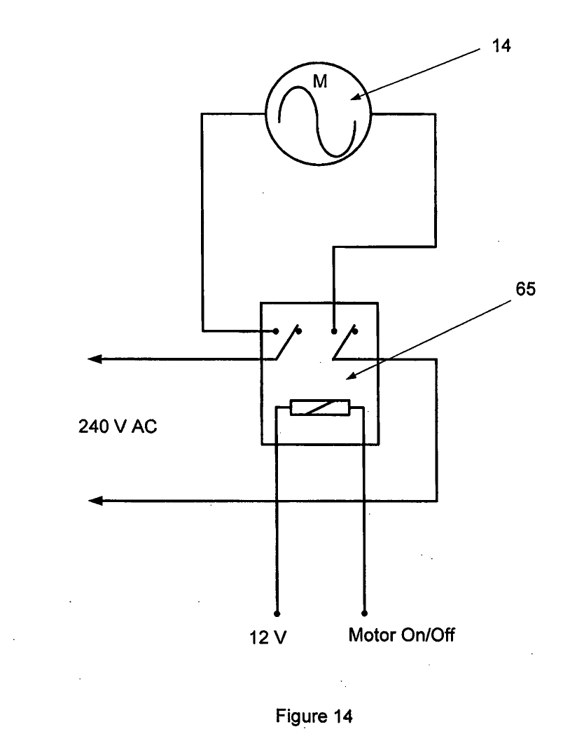

If, for example, the safety switch has been set to detect an overload of 500 Nmm in the motor, then a load of 500 Nmm or greater on the motor will cause the unfiltered voltage of the second circuit branch 32 to exceed the predetermined threshold of the voltage limiter 40. The comparator 34 will change the state of its output. The change will cause the timer 60 coupled thereto, to send a clock pulse to the clock input of the JK flip flop 62. The output of the JK flip flop 62 is coupled to the base of transistor 64. The collector of the transistor 64 is coupled to the relay 65 shown in FIG. 14. The relay 65 is controlled by the comparator 34 through the transistor 64. On detection of a shock load or an overload, the comparator 34 sends a control signal to the relay 65 and turns off the motor 14.

A shearer may toggle the remote motor on/off by way of pulling the cord 46 of the toggle on/off device 50, shown in FIGS. 3 and 4.

The safety switch 10 may be used in conjunction with a variable frequency controller 52 coupled between the remote motor 14 and the safety switch 10 in the manner shown in FIG. 2. The variable frequency controller 52 receives power from the safety switch via wire 45 and a low voltage control signal from the safety switch 10 via wire 47. The variable frequency controller 52 improves the effectiveness of the safety switch 10 and includes a built in braking system (not shown) for the motor 14.

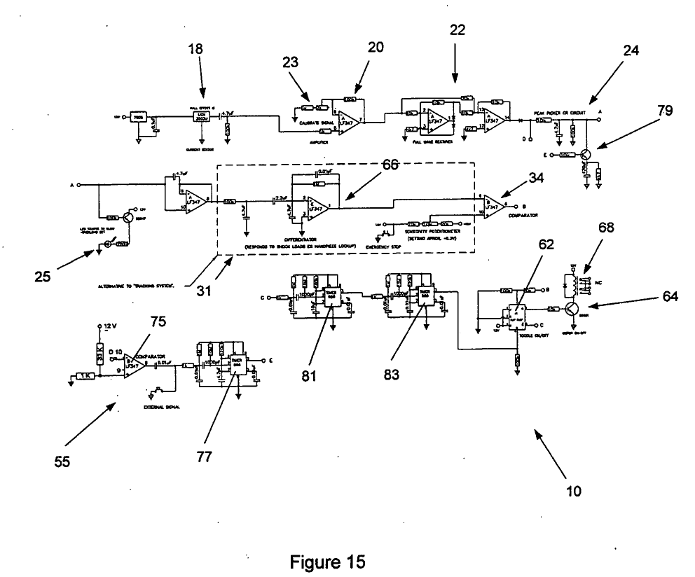

In one embodiment, the safety switch 10 is used to monitor the load of an electric drill (not shown) and includes an alternative electric circuit for tracking system 31, as shown in FIG. 15. The alternative electric circuit for the tracking system 31 is coupled between the sensor 33 and the comparator 34 of the safety switch 10. The alternative electric circuit for the tracking system 31 includes a differentiator 66 that is responsive to shock loads on the electric motor 14 of the drill. The differentiator 66 receives a signal from the peak picker filter 24 of the sensor 33 and differentiates that signal. The differentiated signal represents the rate of change of amplitude of the signal received from the sensor 33. A rapid change in rate may represent a shock load on the motor of the electric drill, for example. The comparator 34 receives an input signal from the differentiator 66 and compares that input signal with a predetermined threshold value and sends a control signal to the set input of JK flip flop 62. The output of the JK flip flop 62 is coupled to the base of transistor 64. The safety switch 10 includes a relay 68 coupled to the collector of the transistor 64. The relay 68 is normally closed. On detection of a shock load, the relay 68 receives a control signal from the comparator 34 via JK flip flop 62 and shuts off power to the motor 14.

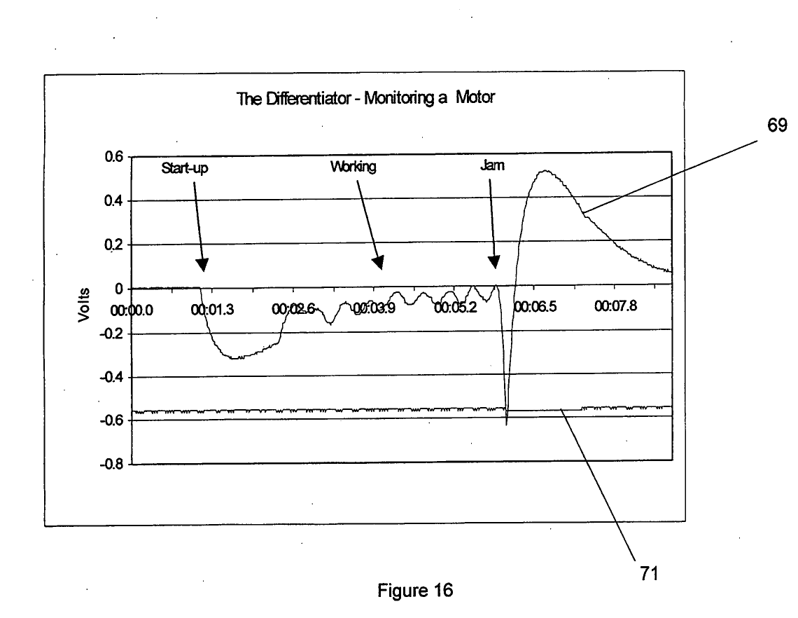

An example of the output of the differentiator 66 is indicated by reference numeral 69 shown in FIG. 16. The predetermined threshold value is indicated by reference numeral 71.

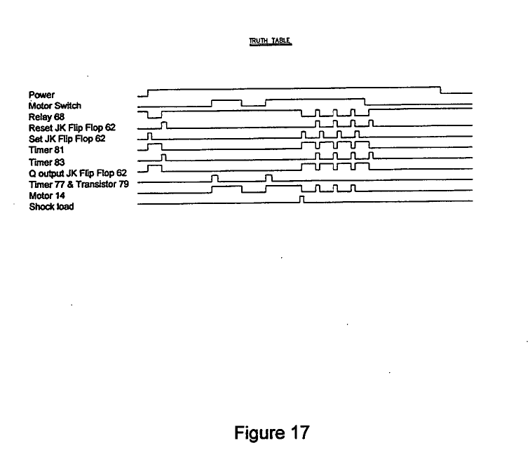

The safety switch 10 shown in FIG. 15 includes the start up compensatory circuit 55 shown in FIG. 15. The compensatory circuit 55 replaces the need for a mechanical clutch and implements an impulse drive action for the motor 14. A transition table showing the state of the components of the safety switch 10 during different stages of use is shown in FIG. 17. The relay 68 is normally closed. Start up current is much higher than normal load current.

The non-inverting leg of the comparator 75 is connected to a voltage divider that holds the non-inverting leg at a voltage level of 0.4 Volts, for example. The inverting leg of the comparator 75 is coupled to the peak picker filter 24 in the manner shown in FIG. 15. In its quiescent state, the output of the comparator 75 is high. As soon as the motor 14 of the electric drill starts, the output of the peak picker filter 24 moves above the 0.4 V of the non-inverting leg of the comparator 75. Consequently, the comparator 75 changes state from high to low and the timer 77 is triggered by the negatively changing edge. The output of the timer 77 is coupled to the base of the transistor 79. The transistor 79 is turned on when the comparator 75 triggers the timer 77 in the described manner. The emitter of the transistor 79 is coupled in parallel to ground by a capacitor and a resistor for a period of time determined by the timer 77. The respective capacitance and resistance of these components determines the effectiveness of start up protection. When turned on in the described manner, the transistor 79 grounds the output of the peak picker filter 24 through these components and thereby prevents the motor from turning off. If start-up takes longer than allowed for by the timer 77, then the motor will turn off.

The electric drill can experience a shock load when, for example, the force required to screw a fastener into a surface increases suddenly due to the fastener being nearly seated in the surface. On detection of such a shock load, the comparator 34 drives the output of the JK flip flop 62, Q, high. The output of the JK flip flop 62 turns on the transistor 64 which, in turn, switches off the relay 68 and shuts off power to the motor 14. The relay 68 is normally closed. The timer 81 is coupled to the Q output of the JK flip flop 62 and is triggered when Q is driven low, i.e. when the comparator 34 drives Q of the JK flip flop 62 high.

When triggered by the negatively changing edge of the JK flip flop 62, the timer 81 effects a delay for a predetermined amount of time and then triggers the timer 83 coupled thereto. When triggered, the timer 83 changes the state of the Q output of the JK flip flop 62 which turns off the transistor 64. The relay 68 is subsequently turned on and the motor 14 is started.

The timer 81 determines the lag between when the motor 14 is shut off due to a shock load and when it will be restarted. The on/off switching of the motor 14 in quick succession causes a pulse screw driving action in the electric drill and helps to seat the fastener in the surface.

The pulse drive action occurs during a jammed condition because the start up compensatory circuit 55 that would normally prevent shock loads at start up is not effected. i.e. during shock loads of this type, the voltage of the peak picker filter 24 does not instantly fall below voltage of the non-inverting leg of the comparator 75 of the start up compensatory circuit 55. The pulse screw action of the drill will continue during a shock load while the user of the drill keeps the motor switch held on. After the motor switch is released by the user, the safety switch 10 resets. The voltage of the peak picker filter 24 falls below that of the voltage (0.4V) of the non-inverting leg of the comparator 75 and enables a normal start.

The safety switch 10 can be used to monitor a 240V AC current supplied to the variable frequency controller 52 and the three phase electric motor 14. The switch is looking for a sudden rise in current caused by a shearing hand piece 17 lock up, for example. If a wool press, or any other large electrical machine, coupled to the same power supply as the motor 14 starts up, then the line voltage may temporarily drop because of the high load of the machine drawing a large amount of current. The change in line voltage may be sufficient to trigger the safety switch 10. The effect is more prevalent when the motor 14 and the machine are connected to a limited capacity power supply.

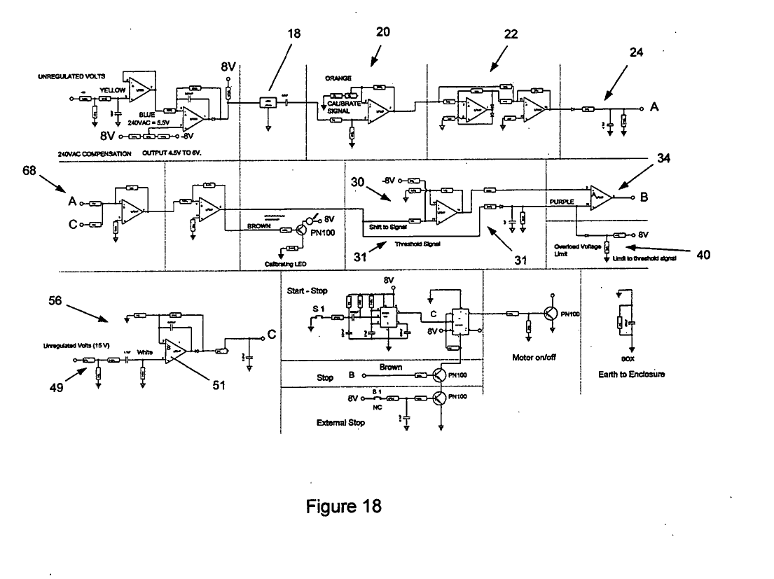

The voltage compensation circuit 56 shown in FIG. 18 off-sets the effect of starting up of any such large machines on the performance of the safety switch 10. The voltage compensation circuit 56 is coupled between the output of the sensor 33 and the tracking system 31 by an adder 68. The adder 68 receives the output of the peak picker filter 24 and the output of the voltage compensation circuit 56 and passes the result to the tracking system 31.

The voltage compensation circuit 56 includes a voltage divider 49 that is coupled between an unregulated 15 V signal and the non-inverting leg of an operational amplifier 51. A 100 K Ohm resistor keeps the non-inverting leg of the op-Amp 51 at around earth potential. A diode coupled to the output of the Op-Amp 51 allows the signal to be pulled down only when the unregulated line voltage suddenly drops, i.e., the output of the amp 51 is pulled down. The output signal of the voltage compensation circuit 56 is filtered and passed on to the input of the adder 68.

When a large machine coupled to the same power supply as the motor 14 starts, the adder 68 receives a signal from the sensor 33 that is going up with the large machine start and a signal receive from the voltage compensation circuit 56 that is pulled down. The result is that the voltage compensation circuit 56 cancels out the interference caused on the signal received from the sensor 33 as a result of the large machine starting up.

In many rural areas the power supply capacity varies over time and, consequently, the available voltage at a particular location can vary above and below the nominal power supply voltage. The safety switch's sensitivity varies in accordance with the variance in the mains voltage. To compensate for this, a person using the motor 14 can vary the supply volts to the Hall effect sensor 18.

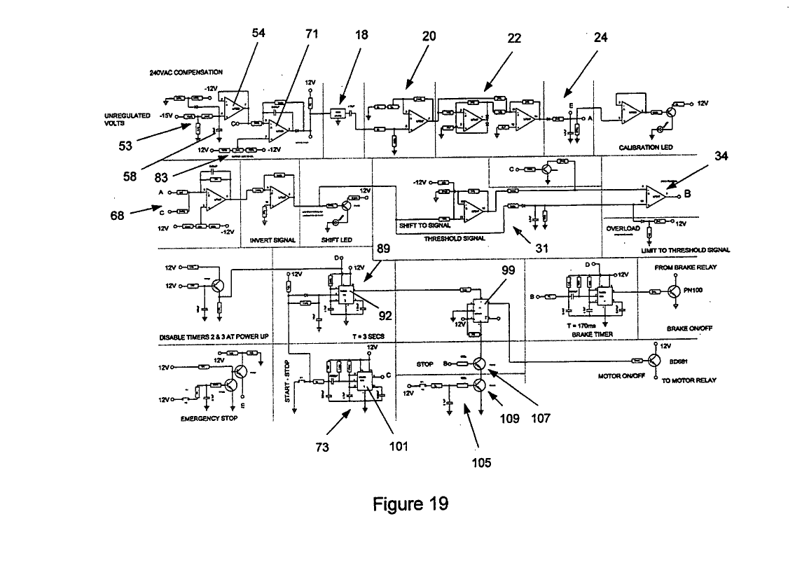

The unregulated −15V of the power supply of the electric circuit for the safety switch 10 shown in FIG. 19 is divided by voltage divider 53 and slowly charges the capacitor 58. This goes to a buffer A at the non-inverting amplifier 54. The buffered signal goes on to an inverting amplifier 71 coupled to the output of the non-inverting amplifier 54. The inverting amplifier 71 has a diode coupled to its output. The overall output of the inverting amplifier 71 is controlled by the potentiometer 83 coupled to the inverting leg of the inverting amplifier 71, say 240 V=5.5 Vdc. The variation in supply of the Hall Effect sensor 18 can swing from 4.5 to 6.0.

When the circuit of the safety switch 10 is powered up, minimum operating volts is supplied to the Hall Effect sensor 18 via the 1 K Ohm resistor. This is then slowly overridden by the output of the compensating circuit until reaching operating volts determined by the line volts.

To maintain our overall load setting for the induction motor 14, as the 240 V AC supply increases, the signal from the Peak Picker Filter 24 is pulled down at adder 68. The controlling volts come from the start attenuator 73 at 1 240 V AC compensation output 4.5V to 6V.

In the case that the safety switch 10 is used on an application where the driving motor 14 normally runs continuously and a clutch system is used to connect the driven load to the motor, the safety switch 10 may see the engagement of the motor as sufficient shock load to cause the safety circuit to trigger and stop the motor. An example of this is most older style overhead shearing machines.

To remove this as a trigger to stop the motor, a switch is fitted to the clutch operating lever and the start attenuator circuit 85 is used.

In use, the motor 14 is started while the switch SI closed, i.e., hold the toggle down. In doing so, the 10 uF capacitor of the motor start circuit 89 switch slowly discharges and the Timer 92 is eventually is triggered. The timer 92 sets the JK Flip Flop 99, thereby turning the motor 14.

A quick pull to toggle machine into gear only starts Timer 101 at the start attenuator circuit 74. This gets the machine past the shock of starting up as above described.

The external stop switch 105 is used to stop the motor 14 from a location remote from the motor 14 and the safety switch circuit 10. The external stop switch 105 functions as a failsafe stop circuit. The external stop switch 105 replaces the above described stop circuit.

Instead of “clocking” the JK Flip Flop, it is reset by the comparator 34 switching off the STOP transistor PN100 107 causing the Flip Flop 80 to reset via the 1 M resistor.

The external stop switch 105 operates the same way when its switch is opened. Transistor PN100 109 stops conducting forcing the JK Flip Flop 80 to reset therefore switching motor 14 off.

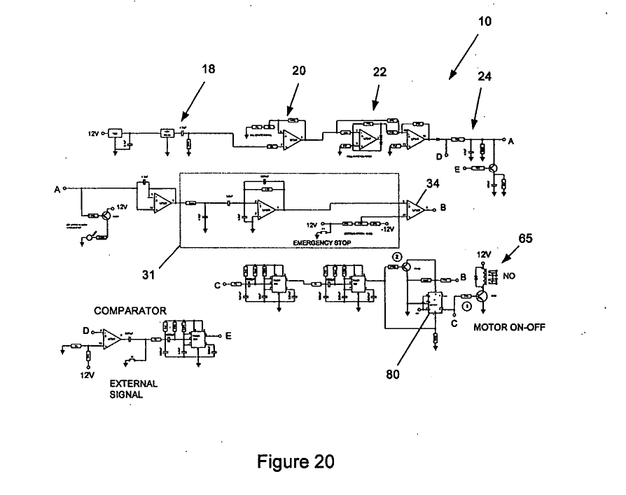

The Safety switch 10 shown in FIG. 20 is configured so that the relay 65 is coupled to the complimentary output of the JK Flip Flop 80 and used as Normally Opened. This has been done only for safety reasons, i.e., the switch 10 will be powered up before the motor 14 can operate.

2. The Rotational Speed of the Motor

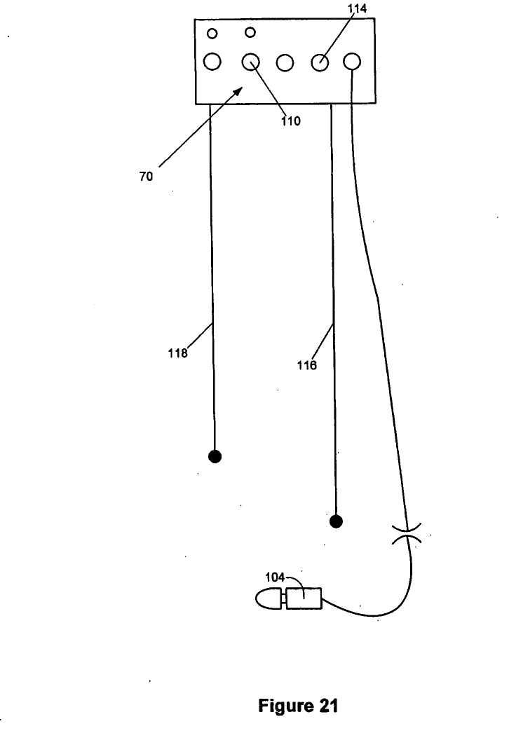

The safety switch 70 shown in FIG. 21 is responsive to changes in the rotational speed of a transmission of a motor (not shown). The safety switch 70 determines the rotational speed of the transmission coupled to and driven by the motor. The safety switch 70 retards the motor if the rotational speed falls below a predetermined limit, or when the rotational speed unexpectedly and rapidly drops. The safety switch 70 retards the motor by cutting power to the motor, for example. The safety switch 70 can, alternatively, retard the motor by use of a brake or any other suitable means. The safety switch 70 can also retard the transmission by use of a solenoid to pull the transmission out of gear.

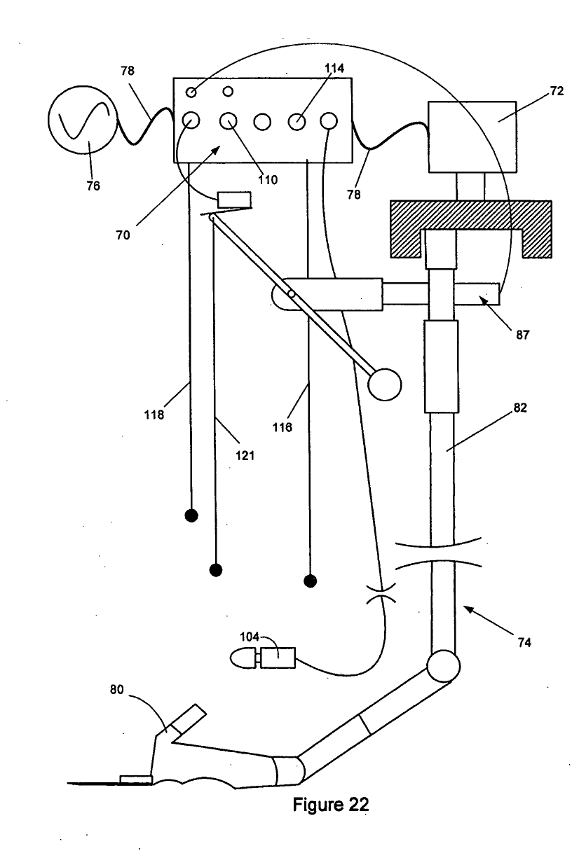

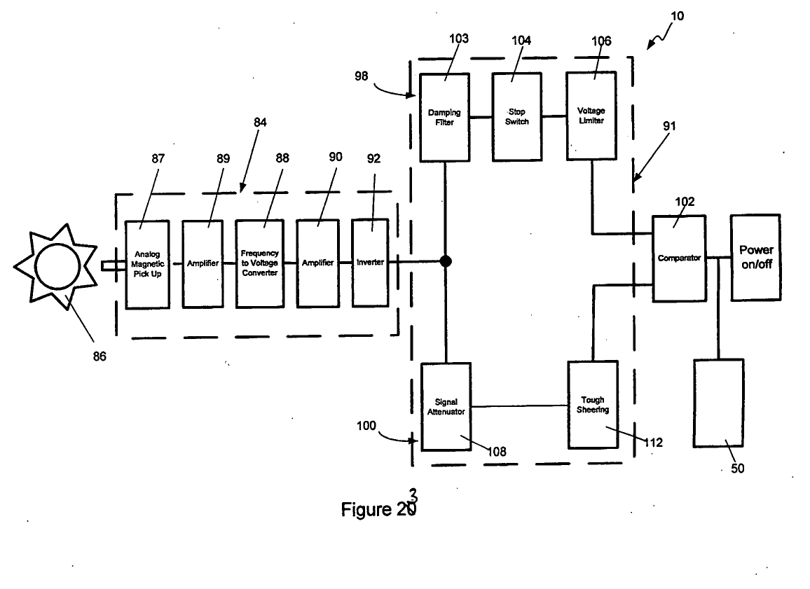

The safety switch 70 is hereafter described by way of reference to the electric motor 72 of the shearing apparatus 74 shown in FIG. 22. However, it would be understood by those skilled in the relevant art that the safety switch 70 can be used to monitor the rotational speed of any motor, or rotating component. The shearing apparatus 74 includes a power source 76 and a hand piece 80. The electric motor 72 drives the hand piece 80 via the down tube 82. The safety switch 70 is coupled between the power source 76 and the electric motor 72 by insulated electrically conductive wires 78.

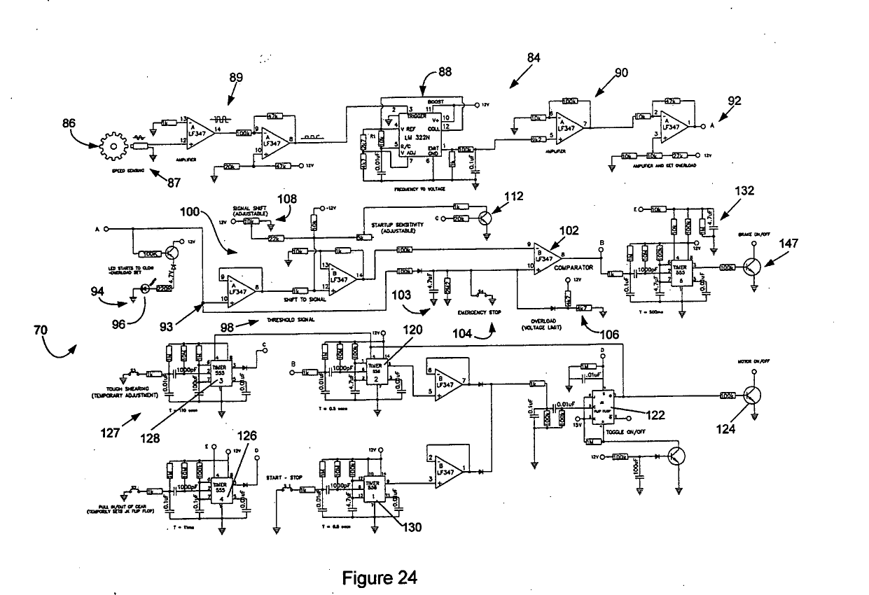

The safety switch 70 includes a tracking system 91 coupled between a sensor 84 and a comparator 102 arranged in the manner shown in FIGS. 23 and 24. The sensor 84 determines the rotational the speed of the down tube 82 and represents that speed as a voltage signal varying with respect to time. The sensor 84 includes a ferrous-toothed wheel 86 secured to the down tube 82 of the shearing apparatus 74 so that the wheel 86 rotates co-axially with the down tube 82. The wheel 86 rotates under the control of the down tube 82. An analog magnetic pick up 87 is positioned adjacent the wheel 86 such that the ferrous-teeth of the wheel 86 pass the pick up 87 as the wheel 86 rotates under the influence of the down tube 82. The pick up 87 detects changes in flux density as each ferrous tooth passes the pick up 87. The output of the pick up 87 is amplified by amplifier 89. The amplified signal is then used as a trigger for a frequency to voltage converter 88. The output of the converter 88 is amplified by amplifier 90 and then inverted by the inverter 92. The output of the sensor 84 is a voltage varying with respect to time that represents the inverted rotational speed of the down tube 82. The voltage is inverted so that the remaining part of the safety switch 10, i.e. the tracking system, the comparator and the braking system, is analogous to that of the above-described safety switch 10.

The output signal of the sensor 84 is received by jammed indicator 94. The jammed indicator 94 illuminates a light emitting diode 96 on detection of an overload in the remote motor 72. The light emitting diode 96 can be used as a visual indicator when calibrating the safety switch 70.

The output signal of the sensor 84 is received by the tracking system 91 and split at a junction 93 into first and second circuit branches 98, 100. Each circuit branch 98, 100 is coupled between the output of the sensor 84 and respective first and second inputs of the comparator 102. The output of the comparator 102 changes state if it detects that the signal received from the second circuit branch 100 is greater than the signal received from the first circuit branch 98. First Circuit Branch

In the first circuit branch 98, the output signal of the rotational speed sensor 84 is received by damping filter 103. The damping filter 103 receives and damps the output signal of the sensor 84. The damping filter 103 slows the rate of change in the signal received from the sensor 84.

The damped output signal of the damping filter 103 is received by an emergency stop switch 104 coupled thereto. When activated, the emergency stop switch 104 grounds the damped output signal of the damping filter 103. The emergency switch 104 otherwise allows the damped output signal of the damping filter 103 to pass through to a voltage limiter 106.

The voltage limiter 106 is coupled between the emergency safety switch 104 and the first circuit branch input of the comparator 102. When the emergency safety switch 104 has not been activated, the voltage limiter 106 receives the damped output signal from the damping filter 103 and prevents that signal from exceeding a predetermined limit.

Second Circuit Branch

The second circuit branch 100 includes a signal attenuator 108 that receives the output signal of the sensor 84. The signal attenuator 108 includes a dial 110 that controls the resistance of a variable resistor. A person is able to adjust the attenuation of the output signal of the sensor 84 by rotating the dial 110. The person thereby controls the degree to which the amplitude of the signal of the second circuit branch 100 corresponds to that of the first circuit branch 98, i.e., the sensitivity of the safety switch 70.

The output of the signal attenuator 108 is received by a tough sheering attenuator 112, 127 coupled thereto. The tough sheering attenuator 112, 127 is activated by way of pulling a cord 116. The shearer may pull the cord 116 when he/she anticipates that the rotational speed of the down tube 82 may be temporarily slow.

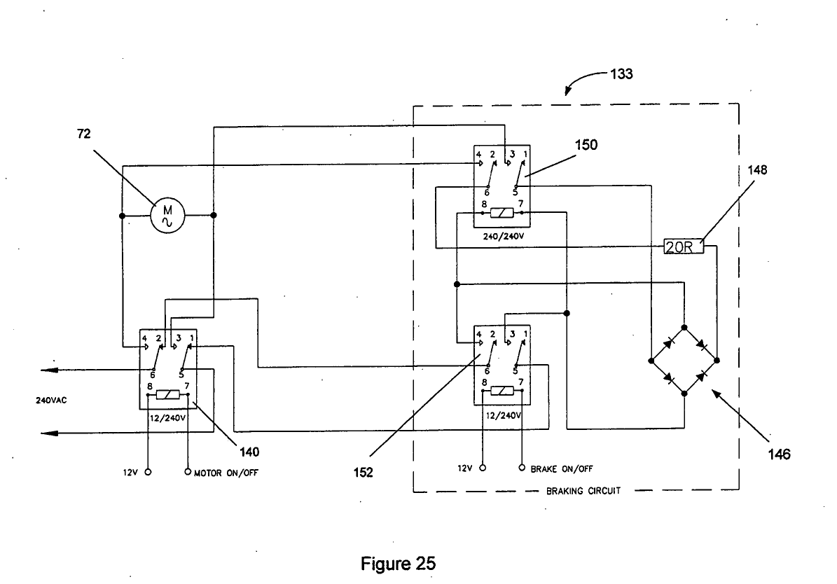

The comparator 102 compares the input signal from the first circuit branch 98 with the input signal from the second circuit branch 100 changes state if it detects that the signal received from the second circuit branch 100 is greater than the signal received from the first circuit branch 98. The change will cause the timer 120 coupled thereto to send a clock pulse to the clock input of the JK flip flop 122. The output Q of the JK flip flop 122 is coupled to the base of transistor 124. The collector of the transistor 124 is coupled to the relay 140 shown in FIG. 25. The relay 140 retards the motor 72 in response to the change in state of the output of the comparator 102 by disconnecting the motor 72 from the 240V AC power supply 76. In an alternative embodiment, the transistor 124 energises a solenoid and pulls the transmission out of engagement with the motor 72.

Where the down tube 82 of the sheering apparatus 74 changes rotational speed slowly, the two signals received by the comparator 102 will rise or fall at about the same rate. However, if a rotational speed decreases to the point where the attenuated output signal of the second circuit branch 100 is greater than the mentioned predetermined limit of the voltage limiter, then the output comparator 102 will change state. The changed state of the output of the comparator 102 retards the motor 72.

If the rotational speed of the down tube is normal, i.e., the signal received by the comparator 102 from the first circuit branch 98 is well below the predetermined limit, and the down tube 82 experiences an unexpected and rapid reduction in rotational speed, then the attenuated signal of the second circuit branch 100 may temporarily be greater than the damped signal of the first circuit branch 98. The comparator 102 changes state on detection of this change and the safety switch 70 retards the motor 72.

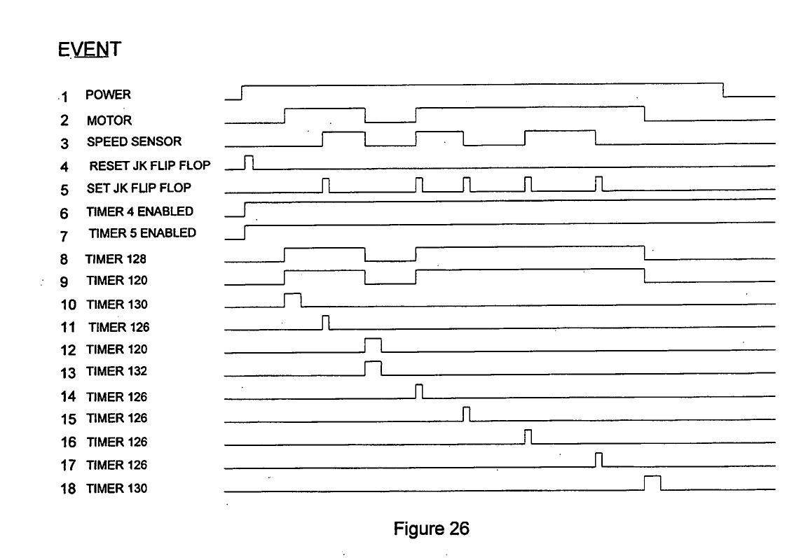

When the safety switch 70 is powered up, the JK flip flop 122 is reset and the timers 126 and 132 are disabled. The transition table shown in FIG. 26 shows exemplary timing of these steps. Timer 128 is disabled at power up and then reset so as to have a low state. Timers 120 and 128 are held low by the output of the JK flip flop 122. This disables the timers. Similarly, the timer 128 is held low by the output of the JK flip flop 122.

Timer 130 then starts the motor and enables timer 120 and timer 128. Timer 126 is then started by switch on toggle. The drive to the shearing hand piece is engaged and a signal is obtained from the speed sensor. Timer 120 is triggered by the comparator 102 as a result of a hand piece lock up. The output of the JK flip flop 122 goes low and thereby switches power off to the motor 72 by use of transistor 124.

A small pull on the toggle on/off rope 118 restarts the motor 72. The JK flip flop 122 is thereby forced high by the timer 126. The timer 126 otherwise keeps the output of the flip flop 122 high

The safety switch 70 also includes a braking circuit 133 shown in FIG. 25. The braking circuit 133 is coupled to the collector of the transistor 147 shown in FIG. 24. The transistor 147 is coupled to the comparator 102 by a timing circuit 132 and turns on the braking circuit 133 when the output of the comparator 102 changes state.

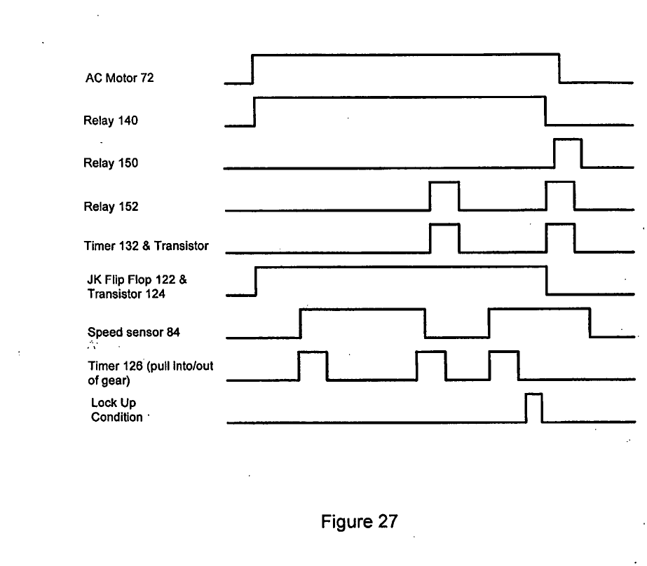

The transistor 147 is coupled to a first relay 152 of the braking circuit 133 which in turn coupled to a second relay 150. The transistor 147 enables the first relay 152 which in turn enables the second relay 150. When enabled, the second relay 150 rectifies the 240 V AC signal being supplied to the motor 72. Rectification of the 240 V AC signal has the effect of retarding the induction motor 72 in a very quick manner. Rectification is achieved by coupling the motor 72 to a diode bridge 146 in the manner shown in FIG. 25. The deceleration is controlled by the magnitude of the resistor 148. FIG. 27 shows the state of the components of the braking system during different stages of use.

The braking circuit 133 can also be coupled to the safety switch 10 shown in FIGS. 4 and 15 and used to retard the motor 14 in the above-described manner.

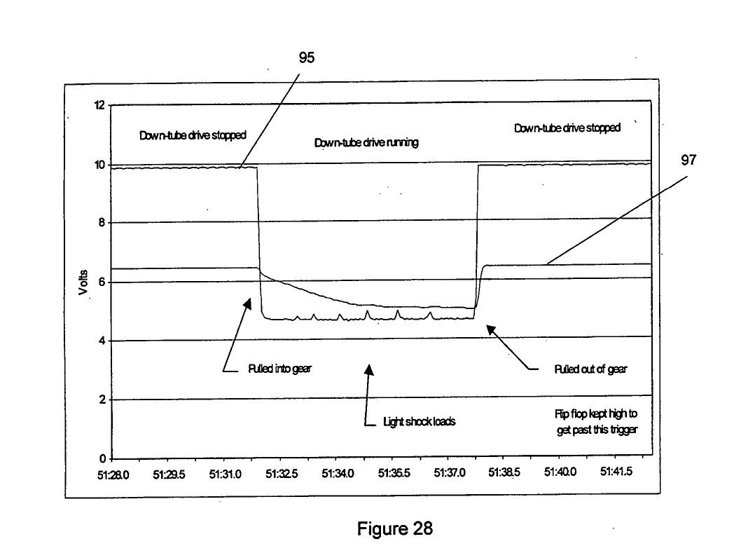

In one embodiment, the comparator 102 retards the down tube 82 by pulling the motor 72 out of gear. In this embodiment, the motor 72 need not be stopped and restarted for each sheep to be shorn and may be any suitable motor (e.g., electric, petrol, diesel or the like). The timer 126 is used to set the JK flip flop 122. Setting the JK flip flop will either cause the motor to start or to get the motor 72 past the shock of the down tube 82 being pulled out of gear. The timer 126 is set to cause a delay of approximately 11 milliseconds. During this period of time, the clock input of the JK flip flop 122 has no effect. As the drive slows, the shifted volts indicated by reference numeral 95 in FIG. 28 go above reference volts indicated by reference numeral 97. Subsequently, the output of the comparator 102 changes state from high to low and the timer 120 is triggered on the negative edge of this change. The clock input of the JK flip flop 122 is then triggered by the timer 120. The signal to force the flip flop 122 high comes from the limit switch on the shearing apparatus 74. The connection from the safety switch 70 to the limit switch is by way of knob. The rope 121 is used to toggle the tough shearing machine 74. A small pull on the rope 121 starts the motor 72. The timer 126 sets the JK flip flop 122.

The safety switch 70 alternatively includes the alternative tracking system 31 shown in FIG. 15.

While the safety switch 70 has been described by way of reference to the electric motor 72 shown in FIG. 21, the safety switch 70 may be used in conjunction with any suitable motor. Examples are power drills, angle grinders etc.

The safety switch 10, 70 can be implemented using a suitable combination of firmware and hardware components. For example, the safety switch 10 may include a microcontroller to monitor the load on the electric motor 14 and to generate a control signal for the motor 14. Further, the safety switch 70 may include a microcontroller to monitor the rotational speed of the motor 72 and to generate a control signal for the motor 72.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A safety switch to control the operation of a motor, the safety switch comprising:
(a) a sensor configured to generate a signal representing an operating condition of the motor;
(b) a filter configured to attenuate a rate of change of said signal and to generate a filtered signal; and
(c) a controller configured to generate a control signal for the motor in response to a predetermined difference between said signal representing the operating condition of the motor and the filtered signal.

2. The safety switch of claim 1, wherein the controller is configured to generate said control signal for the motor if said signal representing the operating condition of the motor is greater than the filtered signal.

3. The safety switch of claim 1, wherein the controller is configured to generate said control signal for the motor if said signal representing the operating condition of the motor is greater than a predetermined threshold.

4. The safety switch of claim 1, further comprising an attenuator configured to attenuate said signal representing the operating condition of the motor and to generate an attenuated signal, wherein the controller is configured to generate said control signal for the motor if said attenuated signal is greater than the filtered signal.

5. The safety switch of claim 4, wherein the controller is configured to generate said control signal for the motor if said attenuated signal is greater than said predetermined threshold.

6. The safety switch of claim 4, wherein the attenuator is adjustable so as to change the degree of attenuation used to generate said attenuated signal.

7. The safety switch of claim 6, wherein the attenuator comprises an override to further attenuate said signal representing the operating condition of the motor for a predetermined period of time.

8. The safety switch of claim 1, wherein the motor is an electric motor and the control signal is configured to switch off the motor.

9. The safety switch of claim 1, further comprising a brake in communication with the controller, said brake being configured to retard the motor on receipt of said control signal from the controller.

10. The safety switch of claim 1, wherein the operating condition is the load on the motor.

11. The safety switch of claim 1, wherein the operating condition is the rotational speed of the motor.

12. A safety switch to control the operation of a motor, the safety switch comprising:
(a) a sensor configured to generate a signal representing an operating condition of the motor; and
(b) a controller configured to generate a control signal for the motor if said signal representing the operating condition of the motor is greater than a predetermined threshold.

13. The safety switch of claim 12, further comprising an attenuator configured to attenuate said signal representing the operating condition of the motor so as to generate an attenuated signal, and wherein said controller is further configured to generate said control signal for the motor if said attenuated signal is greater than the predetermined threshold.

14. A safety switch to control the operation of a motor, said safety switch comprising:
(a) a sensor configured to generate a signal representing rate of change of an operating condition of the motor; and
(b) a controller configured to generate a control signal for the motor in response to a predetermined condition in said signal representing rate of change of an operating condition of the motor.

15. The safety switch of claim 14, wherein the controller is configured to generate said control signal if the rate of change is above a predetermined threshold.

16. The safety switch of claim 14, wherein the motor is an electric motor and the control signal is configured to switch off the motor.

17. The safety switch of claim 14, further comprising a brake in communication with the controller, said brake being configured to retard the motor on receipt of said control signal from the controller.

18. The safety switch of claim 14, wherein the operating condition is the load on the motor.

19. The safety switch of claim 14, wherein the operating condition is the rotational speed of the motor.

20. A safety switch to control the operation of a motor, the safety switch comprising:
(a) a sensor responsive to changes in load of the motor and configured to represent those changes as a signal varying with respect to time;
(b) a filter configured to damp the signal varying with respect to time; and
(c) a controller configured to generate a control signal for the motor if said signal varying with respect to time is greater than the signal damped by the filter.

21. A motor assembly comprising:
(a) a motor;
(b) a sensor configured to generate a signal representing an operating condition of the motor;
(c) a filter configured to attenuate a rate of change of said signal and to generate a filtered signal; and
(d) a controller configured to generate a control signal for the motor in response to a predetermined difference between said signal representing the operating condition of the motor and the filtered signal.

22. The motor assembly of claim 21, wherein the controller is configured to generate said control signal for the motor if said signal representing the operating condition of the motor is greater than the filtered signal.

23. The motor assembly of claim 21, wherein the controller is configured to generate said control signal for the motor if said signal representing the operating condition of the motor is greater than a predetermined threshold.

24. The motor assembly of claim 21, further comprising an attenuator configured to attenuate said signal representing the operating condition of the motor and to generate an attenuated signal, wherein the controller is configured to generate said control signal for the motor if said attenuated signal is greater than the filtered signal.

25. The motor assembly of claim 24, wherein the controller is configured to generate said control signal for the motor if said attenuated signal is greater than said predetermined threshold.

26. The motor assembly of claim 24, wherein the attenuator is adjustable so as to change the degree of attenuation used to generate said attenuated signal.

27. The motor assembly of claim 26, wherein the attenuator comprises an override to further attenuate said signal representing the operating condition of the motor for a predetermined period of time.

28. The motor assembly of claim 21, wherein the motor is an electric motor and the control signal is configured to switch off the motor.

29. The motor assembly of claim 21, further comprising a brake in communication with the controller, said brake being configured to retard the motor on receipt of said control signal from the controller.

30. The motor assembly of claim 21, wherein the operating condition is the load on the motor.

31. The motor assembly of claim 21, wherein the operating condition is the rotational speed of the motor.

32. A safety switch to control the operation of a motor, the safety switch comprising:
(a) means for sensing an operating condition of the motor, and generating a signal representing an operating condition of the motor;
(b) means for attenuating a rate of change of said signal and generating a filtered signal; and
(c) means for generating a control signal for the motor in response to a predetermined difference between said signal representing the operating condition of the motor and the filtered signal.

33. The safety switch of claim 32, wherein the means for generating a control signal is configured to generate said control signal for the motor if said signal representing the operating condition of the motor is greater than the filtered signal.

34. The safety switch of claim 32, wherein the means for generating a control signal is configured to generate said control signal for the motor if said signal representing the operating condition of the motor is greater than a predetermined threshold.

35. The safety switch of claim 32, wherein the operating condition is the load on the motor.

36. The safety switch of claim 32, wherein the operating condition is the rotational speed of the motor.

37. A method of safety switching to control the operation of a motor, the method comprising:
(a) generating a signal representing an operating condition of the motor;
(b) attenuating a rate of change of said signal and generating a filtered signal; and
(c) generating a control signal for the motor in response to a predetermined difference between said signal representing the operating condition of the motor and the filtered signal.
